(19) United States
(12) Patent Application Publication
(10) Pub. No.: US 2004/0252762 A1
(43) Pub. Date: Dec. 16, 2004

(54) System, method, and apparatus for reducing memory and bandwidth requirements in decoder system

(76) Inventors: R. Lakshmikanth Pai, Bangalore (IN); Chhavi Kishore, Bangalore (IN); Srinivas Cheedella, Bangalore (IN)

Correspondence Address: MCANDREWS HELD & MALLOY, LTD, 500 WEST MADISON STREET, SUITE 3400, CHICAGO, IL, 60661

(21) Appl. No.: 10/463,243

(22) Filed: Jun. 16, 2003

(51) Int. Cl. H04N 7/12

(52) U.S. Cl. 375/240.16; 375/240.12; 375/240.24

(57) ABSTRACT

A system, method, and apparatus for reducing memory and processing requirements in a decoder system are presented herein. The memory and processing requirements are reduced by generating virtual pixels on the fly. Generating the virtual pixels on the fly, as opposed to storing the virtual pixels reduces the memory requirements of the frame buffer. Additionally, generation on the fly also reduces the fetch instructions required to retrieve the virtual pixels from the frame buffer.

### RELATED APPLICATIONS

[Not Applicable]

### FEDERALLY SPONSORED RESEARCH OR DEVELOPMENT

[Not Applicable]

[MICROFICHE/COPYRIGHT REFERENCE]

[Not Applicable]

### BACKGROUND OF THE INVENTION

Media compression standards developed by the Motion Picture Experts Group (MPEG), such as MPEG-2 and MPEG-4, use both spatial and temporal coding to reduce the amount of memory and bandwidth required in the storage and transportation of video.

Temporal coding takes advantage of redundancies between successive pictures. For example, a picture can be represented by an offset picture from another picture. Motion reduces the similarities between pictures and increases the data needed to create the difference picture. When an object moves across a screen, it may appear in a different place in each picture, but does not change in appearance very much. The picture offset can be reduced by measuring the motion of the object and using a motion vector to describe the spatial displacement of the object. During decoding, the motion vector is used to shift part of the reference picture to a more appropriate place in the new picture.

In MPEG-2 and MPEG-4, one or more vector controls the shifting of an entire area of the picture that is known as a macroblock. A macroblock represents a 16-pixel by 16-pixel portion of the picture. During encoding, the motion of the macroblock is determined by comparing the portion represented by a macroblock to other 16-pixel by 16-pixel portions at all possible displacements in the reference picture. When a portion with the greatest correlation is found, the offset and the spatial displacement between the region and the macroblock are recorded. The DCT of the offset is encoded, while the spatial displacement is represented by a motion vector.

During decoding, an IDCT function recovers the offset. The offset is applied to the portion in the reference picture to recover the original portion represented by the macroblock. The portion in the reference picture is located by applying the motion vector to the spatial position of the portion represented by the macroblock.

In MPEG-4, portions represented by macroblocks are also compared to portions in reference pictures that are terminated by edges. Portions that are terminated by edges are smaller than the portions represented by macroblocks. To make an adequate comparison, the edge pixels are repeated as necessary to increase the size of the portion terminated by the edge to the size of the portion represented by the macroblock. The repeated pixels are known as virtual pixels.

During decoding, a decoder decodes the reference picture and stores the reference picture in a frame buffer. The decoder then uses the decoded reference picture in the frame buffer to decode other pictures. The pictures that are predicted from the reference picture are decoded by applying the differences contained in each macroblock to the region of the reference picture indicated by the motion vectors. Because in MPEG-4, the portions represented by macroblocks can be predicted from portions in the reference picture that are terminated by edges, the decoder needs to have access to the virtual pixels.

Access to the virtual pixels is provided by storing all of the virtual pixels that can possibly be predicted from when decoding the reference picture. In the case where macroblocks represent 16-pixels×16-pixels, the virtual pixels stored with the reference picture comprise 15 columns and rows on each side of the reference picture. During decode, the decoder fetches the portion from which the macroblock is predicted. Where the portion comprises virtual pixels, the decoder fetches the virtual pixels as well as the pixels in the region terminated by an edge.

The foregoing unnecessarily increases the memory and bandwidth requirements. The memory requirements are increased for storing the virtual pixels. The bandwidth requirements are increased because, although the virtual pixels are repeated, processing cycles are used to fetch the virtual pixels.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system, method, and apparatus for reducing memory and bandwidth in decoder systems are presented herein. In one embodiment, there is presented a method for decoding pictures by receiving an encoded portion of a predicted picture, wherein the encoded portion of the predicted picture is predicted from a portion of a reference picture, retrieving the portion of the reference picture, and repeating edge pixels from the portion of the reference picture after retrieving the portion of the reference picture, wherein the portion of the reference picture is terminated by the edge pixels.

In another embodiment, there is presented a circuit for decoding pictures, comprising a decoder and a memory storing instructions for execution by the decoder. The instructions include receiving an encoded portion of a predicted picture, wherein the encoded portion of the predicted picture is predicted from a portion of a reference picture, retrieving the portion of the reference picture, and repeating edge pixels from the portion of the reference picture after retrieving the portion of the reference picture, wherein the portion of the reference picture is terminated by the edge pixels.

In another embodiment, there is presented a system for decoding pictures. The system includes a presentation buffer for providing an encoded portion of a predicted picture, wherein the encoded portion of the predicted picture is predicted from a portion of a reference picture, a frame buffer for providing the portion of the reference picture, and a decoder for repeating edge pixels from the portion of the reference picture after retrieving the portion of the reference picture, wherein the portion of the reference picture is terminated by the edge pixels.

These and other advantages and novel features of the embodiments in the present application will be more fully understood from the following description and in connection with the drawings.

### BRIEF DESCRIPTION OF SEVERAL VIEWS OF THE DRAWINGS

FIG. 1 is a block diagram describing a reference picture and a predicted picture;

FIG. 2 is a block diagram of a decoder system in accordance with an embodiment of the present invention;

FIG. 3 is a flow diagram describing the operation of the decoder in accordance with an embodiment of the present invention;

FIG. 4A is a block diagram of a series of frames;

FIG. 4B is a block diagram of a reference picture and a predicted picture;

FIG. 4C is a block diagram describing the MPEG-4 hierarchy;

FIG. 5 is a block diagram describing an MPEG-4 decoder in accordance with an embodiment of the present invention; and

FIG. 6 is a flow diagram for decoding a picture in accordance with an embodiment of the present invention.

### DETAILED DESCRIPTION OF THE INVENTION

Media compression standards developed by the Motion Picture Experts Group (MPEG), such as MPEG-2 and MPEG-4, use both spatial and temporal coding to reduce the amount of memory and bandwidth required in the storage and transportation of video.

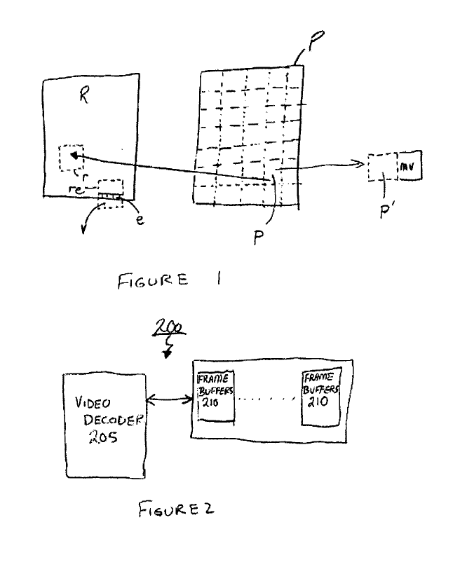

Temporal coding takes advantage of redundancies between successive pictures. Referring now to FIG. 1, there is illustrated block diagram of a reference picture R and a predicted picture P. The predicted picture P can be divided into portions p represented by an offset or a difference p′ from a corresponding portion r in reference picture R.

Motion reduces the similarities between the picture portion p and the corresponding portion r in the reference picture. This increases the data needed to create the difference p′. When an object moves across a screen, it may appear in a different place in each picture, but does not change in appearance very much. The difference can be reduced by measuring the motion of the object and using a motion vector to describe the spatial displacement of the object.

During encoding, the motion of the portion p in the predicted picture P is determined by comparing the portion p to other portions r at all possible displacements in the reference picture R. When the portion r in the reference picture with the greatest correlation to the portion p is found, the difference p′ and the spatial displacement between the portions, r and p, are recorded. The DCT of the difference p′ is encoded, while the spatial displacement is represented by a motion vector, mv.

The portions p in the predicted picture P are also compared to portions re in reference pictures R that are terminated by edges e. Portions that are terminated by edges, re are smaller than the portions p. To make an adequate comparison between the portion p and a portion terminated by an edge re, the edge pixels e are repeated as necessary to increase the size of the portion terminated by the edge re to the size of the portion p. The repeated pixels are known as virtual pixels v.

During decoding, the reference picture R is decoded and stored. The decoded reference picture R is then used to decode the predicted picture P. The predicted picture P is decoded by applying the differences p′ for each portion p in the predicted picture P to the portion r of the reference picture R indicated by the motion vectors mv. Because the portions p can be predicted from portions re in the reference picture R that are terminated by edges, access to the virtual pixels v is needed.

Access to the virtual pixels v is provided by generating, on the fly, the virtual pixels v, whenever a portion p is predicted from a portion re terminated by an edge. The virtual pixels v are generated on the fly, by detecting that a portion p in the predicted picture P is predicted from a portion re in the reference picture R that is terminated by an edge. Responsive thereto, the edge pixels of the portion re are repeated and appended to the portion re, to increase the size of the portion re to the portion p.

Generating the virtual pixels v on the fly, as opposed to storing the virtual pixels reduces the memory requirements of decoders. Additionally, generation on the fly also reduces the fetch instructions required to retrieve the virtual pixels v.

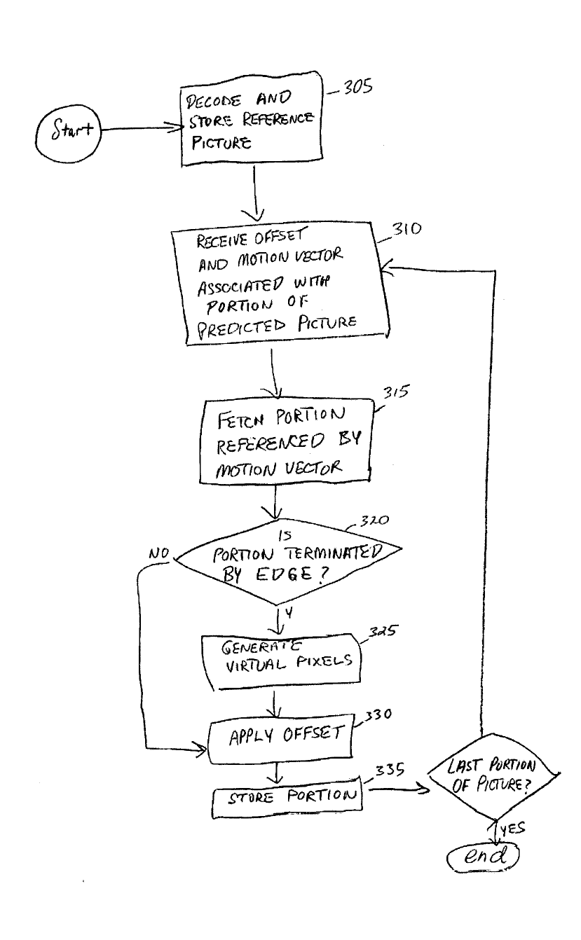

Referring now to FIG. 2, there is illustrated a block diagram of an exemplary decoder system in accordance with an embodiment of the present invention. The decoder system 200 comprises a video decoder 205, and two or more frame buffers 210. During the decoding process, the video decoder 205 decodes the reference picture R and stores the reference picture R in one of the frame buffers 210. The video decoder 205 stores the portions p of the prediction picture P in another one of the frame buffers 210, as each portion p is decoded.

The video decoder 205 decodes the predicted picture P, by reconstructing each portion p forming the predicted picture P. The portion p is reconstructed by applying the offset p′ associated therewith to the portion r in the reference picture R indicated by the motion vector, mv. The video decoder 205 fetches the portion r in the reference picture indicated by the motion vector, mv and applies the offset p′ to recover the portion p.

The motion vector mv may indicate a portion re in the reference picture R that is terminated by an edge of the reference picture R. Where the motion vector mv indicates a portion r in the reference picture R that is terminated by an edge, the virtual pixels v are used for application of the offset p′ to reconstruct the portion p.

Accordingly, when the video decoder 205 fetches the portion r indicated by the motion vector mv, the decoder 205 detects whether the portion r is a portion re terminated by an edge or not. If the portion re is terminated by an edge, the decoder 205 repeats and appends the edge pixels e as necessary to increase the portion re to the size of the portion p associated with the offset p′. The appended edge pixels e represent the virtual pixels v. The video decoder 205 then applies the offset p′ to the portion re and the appended edge pixels e to reconstruct the portion p.

Generating the virtual pixels v on the fly, as opposed to storing the virtual pixels reduces the memory requirements of the frame buffer 210. Additionally, generation on the fly also reduces the fetch instructions required to retrieve the virtual pixels v from the frame buffer 210.

Referring now to FIG. 3, there is illustrated a flow diagram for decoding a predicted picture in accordance with an embodiment of the present invention. At 305, the video decoder 205 decodes and stores the reference picture R in a frame buffer 210. At 310, the video decoder 205 receives an offset p′ and a motion vector mv associated with a portion of the prediction picture P. At 315, the video decoder 205 fetches a portion r of the reference picture R indicated by the motion vector mv from the frame buffer 210.

Upon fetching the portion r of the reference picture R indicated by the motion vector mv from the frame buffer 210, the video decoder 205 determines 320 whether the portion r is a portion re terminated by an edge of the reference picture R. If during 320, the portion r is a portion re terminated by an edge of the reference picture R, the video decoder 205 generates (325) the virtual pixels v by repeating and appending the edge pixels e as necessary until the portion re appending with the virtual pixels v is the size of the portion p associated with the offset p′ received during 310. If during 320, the portion r is not a portion re terminated by an edge of the reference picture R, the video decoder 205 bypasses 325.

At 330, the video decoder 205 applies the offset p′ to either the portion r fetched during 315, or the portion re appended with the virtual pixels during 325 to recover the portion p. At 335, the video decoder 205 stores portion p in the frame buffer 210. The video decoder 205 repeats 310-335 for each portion p in the predicted picture P.

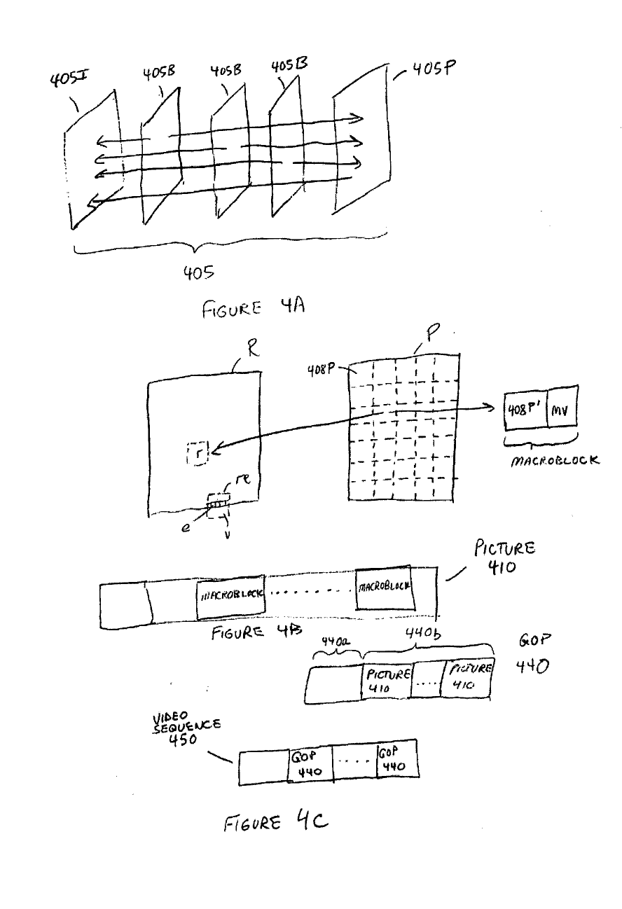

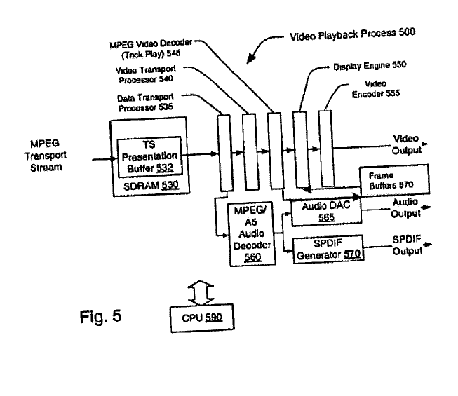

Referring now to FIG. 4A, there is illustrated a block diagram describing the data dependencies of video frames 405 in accordance with MPEG-4. A video comprises a series of successive frames 405. In an exemplary case, the data dependencies can be as indicated by the arrows in the illustration. Pursuant to MPEG-4, the frames 405 can be temporally encoded with respect to one another. MPEG-4 includes I-frames 405I, P-frames 405P, and B-frames 405B. I-frames 405I are not temporally encoded. P-frames 405P are temporally encoded with respect to a single reference frame, while B-frames 405B are temporally encoded with respect to two reference frames. I and P frames are reference frames for prediction frames. The P and B-frames are predicted from reference frames.

Referring now to FIG. 4B, there is illustrated block diagram of a reference picture R and a predicted picture P. The predicted picture P can comprise either a P-frame 405P or a B-frame 405B. In the case where the predicted picture P comprises a B-frame 405B, two reference pictures R are used. The predicted picture P is divided into 16×16 pixel portions 408P represented by an offset 408p′ from a corresponding 16×16 pixel portion r in reference picture R.

During encoding, the motion of a portion 408P in the predicted frame P is determined by comparing the portion 408P to 16×16 pixel portions r at all possible displacements in the reference frame R. When the portion r in the reference frame R with the greatest correlation to the portion 408P is found, the offset 408P′ and the spatial displacement between the portion 408P and the portions r are recorded. In a predicted picture 405P, portions 408P are represented by, among other things, the DCT of the offset 408P′ and a motion vector, mv, describing the spatial displacement of the portion 408P with the region r in the reference picture R.

The portions 408P are also compared to portions re in reference frames R that are terminated by edges 405e. Portions that are terminated by edges, re, are smaller than the portions 408P. To make an adequate comparison between the portion 408P and a portion terminated by an edge re, the edge pixels e are repeated as necessary to increase the size of the portion terminated by the edge re to the size of the portion 408P. The repeated pixels are known as virtual pixels v.

The macroblocks representing the portions 408P forming the picture form part of the payload portion of a data structure representing the picture 410. A series of pictures 410 are grouped into a data structure known as a group of pictures (GOP). Referring now to FIG. 4C, there is illustrated a block diagram of the MPEG hierarchy. The pictures of a GOP are encoded together in a data structure comprising a picture parameter set, which indicates the beginning of a GOP, 440a and a GOP Payload 440b. The GOP Payload 440b stores each of the pictures 410 in the GOP. GOPs are further grouped together to form a video sequence 450. The video data is represented by the video sequence 450.

The video sequence 450 can be transmitted to a receiver for decoding and presentation. The data compression achieved allows for transport of the video sequence 450 over conventional communication channels such as cable, satellite, or the internet. Transmission of the video sequence 450 involves packetization and multiplexing layers, resulting in a transport stream, for transport over the communication channel.

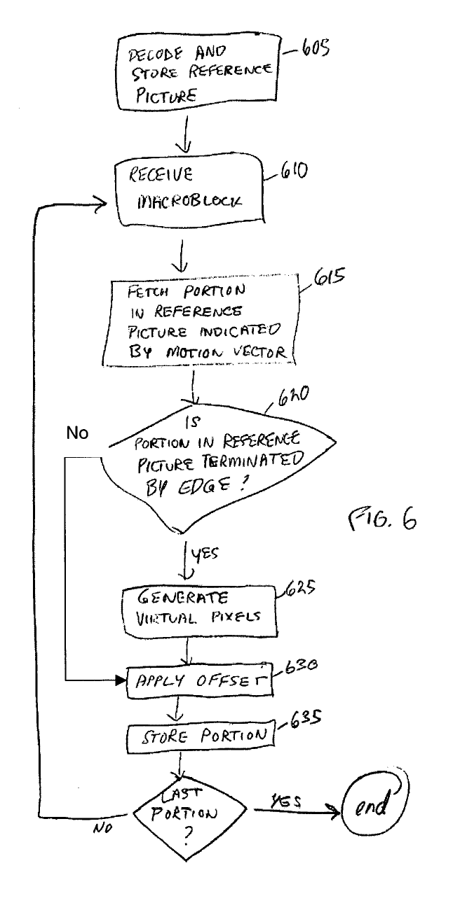

Referring now to FIG. 5, there is illustrated a block diagram of a decoder system 500, in accordance with an embodiment of the present invention. A video sequence 450 is received and stored in a presentation buffer 532 within SDRAM 530. The data can be received from either a communication channel or from a local memory, such as a hard disc or a DVD.

The data output from the presentation buffer 532 is then passed to a data transport processor 535. The data transport processor 535 demultiplexes the transport stream into packetized elementary stream constituents, and passes the audio transport stream to an audio decoder 560 and the video transport stream to a video transport decoder 540 and then to a MPEG video decoder 545. The audio data is then sent to the output blocks, and the video is sent to a display engine 550.

The display engine 550 scales the video picture, renders the graphics, and constructs the complete display. Once the display is ready to be presented, it is passed to a video encoder 555 where it is converted to analog video using an internal digital to analog converter (DAC). Additionally, the display engine 550 is operable to transmit a signal to the video decoder 545 indicating that certain portions of the displayed frames have been presented for display. The digital audio is converted to analog in an audio digital to analog (DAC) 565.

During the decoding process, the video decoder 545 decodes reference pictures R and stores the reference pictures R in one of at least three frame buffers 570. The video decoder 545 stores the decoded portions 408P of the prediction picture P in another one of the frame buffers 570, as each portion 408P is decoded.

The video decoder 545 decodes the predicted picture P, by reconstructing each portion 408P forming the predicted picture P. The portion 408P is reconstructed by applying the offset 408P′ in the macroblock associated therewith, to the portion r in the reference picture R indicated by the motion vector, mv. The video decoder 545 fetches the portion r in the reference picture indicated by the motion vector mv in the macroblock and applies the offset 408P′ to recover the portion 408P.

The motion vector mv may indicate a portion re in the reference picture R that is terminated by an edge of the reference picture R. Where the motion vector mv indicates a portion r in the reference picture R that is terminated by an edge, the virtual pixels v are needed for application of the offset 408P′ to reconstruct the portion 408P. Accordingly, when the video decoder 545 fetches the portion r indicated by the motion vector mv, the decoder 545 detects whether the portion r is a portion re terminated by an edge or not. If the portion re is terminated by an edge, the decoder 545 repeats and appends the edge pixels e as necessary to increase the portion re to the size of the portion 408P associated with the offset 408P′. The appended edge pixels e represent the virtual pixels v. The video decoder 545 applies the offset 408P, to the portion re and the appended edge pixels e to reconstruct the portion 408P, represented by the macroblock.

Generating the virtual pixels v on the fly, as opposed to storing the virtual pixels reduces the memory requirements of the frame buffer 570. Additionally, generation on the fly also reduces the fetch instructions required to retrieve the virtual pixels v from the frame buffer 570.

Referring now to FIG. 6, there is illustrated a flow diagram for decoding a predicted picture in accordance with an embodiment of the present invention. At 605, the video decoder 545 decodes and stores the reference picture R in a frame buffer 570. At 610, the video decoder 545 receives a macroblock comprising an offset 408P′ and a motion vector mv associated with a portion of the predicted picture P. At 615, the video decoder 545 fetches a portion r of the reference picture R indicated by the motion vector mv from the frame buffer 570.

The video decoder 545 determines at 620 whether the portion r is a portion re terminated by an edge of the reference picture R. If during 620, the portion r is a portion re terminated by an edge of the reference picture R, the video decoder 545 generates (625) the virtual pixels v by repeating and appending the edge pixels e as necessary until the portion re appending with the virtual pixels v is the size of the portion 408P associated with the macroblock received during 610. If during 620, the portion r is not a portion re terminated by an edge of the reference picture R, the video decoder 545 bypasses 625.

At 630, the video decoder 545 applies the offset 408P′ to either the portion r fetched during 615, or the portion re appended with the virtual pixels during 625 to recover the portion 408P. At 635, the video decoder 545 stores portion 408P in the frame buffer 570. The video decoder 545 repeats 610-635 for each portion 408P in the predicted picture P.

While the present invention has been described specifically with respect to the MPEG-4 standard, aspects of the present invention may be used in connection with other standards as well, and accordingly such standards are contemplated by and fall within the scope of the present invention.

One embodiment of the present invention may be implemented as a board level product, as a single chip, application specific integrated circuit (ASIC), or with varying levels integrated on a single chip with other portions of the system as separate components. The degree of integration of the monitoring system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor can be implemented as part of an ASIC device with various functions implemented as firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for decoding pictures, said method comprising:
receiving an encoded portion of a predicted picture, the encoded portion of the predicted picture being predicted from a portion of a reference picture;
retrieving the portion of the reference picture; and
repeating edge pixels from the portion of the reference picture after retrieving the portion of the reference picture, the portion of the reference picture being terminated by the edge pixels.

2. The method of claim 1, further comprising:
decoding the reference picture; and
storing the reference picture.

3. The method of claim 1, wherein the encoded portion of the predicted picture comprises one or more motion vectors, the one or more motion vectors indicating the portion of the reference picture.

4. The method of claim 1, wherein the encoded portion of the predicted picture further comprises a macroblock.

5. The method of claim 1, wherein the encoded portion of the predicted picture comprises an offset with respect to the portion of the reference picture, and wherein the method further comprises:
offsetting the portion of the reference picture with the offset.

6. A circuit for decoding pictures, said circuit comprising:
a decoder; and
a memory storing a plurality of instructions executable by the decoder, wherein the plurality of instructions further comprise:
receiving an encoded portion of a predicted picture, the encoded portion of the predicted picture being predicted from a portion of a reference picture;
retrieving the portion of the reference picture; and
repeating edge pixels from the portion of the reference picture after retrieving the portion of the reference picture, the portion of the reference picture being terminated by the edge pixels.

7. The circuit of claim 6, wherein the plurality of instructions further comprise:
decoding the reference picture; and
storing the reference picture.

8. The circuit of claim 6, wherein the encoded portion of the predicted picture comprises one or more motion vectors, the one or more motion vectors indicating the portion of the reference picture.

9. The circuit of claim 6, wherein the encoded portion of the predicted picture further comprises a macroblock.

10. The circuit of claim 6, wherein the encoded portion of the predicted picture comprises an offset with respect to the portion of the reference picture, and wherein the plurality of instructions further comprises:
offsetting the portion of the reference picture with the offset.

11. A system for decoding pictures, said system comprising:
a presentation buffer for providing an encoded portion of a predicted picture, the encoded portion of the predicted picture being predicted from a portion of a reference picture;
a frame buffer for providing the portion of the reference picture; and
a decoder for repeating edge pixels from the portion of the reference picture after retrieving the portion of the reference picture, the portion of the reference picture being terminated by the edge pixels.

12. The system of claim 11, wherein the frame buffer stores the reference picture.

13. The system of claim 11, wherein the encoded portion of the predicted picture comprises one or more motion vectors, the one or more motion vectors indicating the portion of the reference picture.

14. The system of claim 11, wherein the encoded portion of the predicted picture further comprises a macroblock.

15. The system of claim 11, wherein the encoded portion of the predicted picture comprises an offset with respect to the portion of the reference picture, and wherein the decoder offsets the portion of the reference picture with the offset.
